(19) United States
(12) Patent Application Publication
(10) Pub. No.: US 2026/0242616 A1
(43) Pub. Date: Aug. 20, 2026

(54) A WATERBORNE SINGLE STAGE ACRYLIC LATEX WITH SUBSTANTIALLY NO COALESCING AGENTS AND COATINGS FORMED THEREFROM

(71) Applicant: SWIMC LLC, Cleveland, OH (US)

(72) Inventor: Cory MILLER, Chardon, OH (US)

(21) Appl. No.: 19/164,793

(22) PCT Filed: Mar. 26, 2024
(86) PCT No.: PCT/US2024/021431

§ 371 Date: Sep. 12, 2025

Related U.S. Application Data
(60) Provisional application No. 63/493,809, filed on Apr. 3, 2023.

(51) Int. Cl. C09D 5/02; C04B 41/48; C04B 111/00; C08F 20/18; C09D 133/08; C09D 133/10

(52) U.S. Cl. CPC C09D 5/022; C04B 41/483; C08F 20/18; C09D 133/08; C09D 133/10; C04B 2111/00612

(57) ABSTRACT

A latex and coatings composition formed therefrom is provided. The latex includes a single stage acrylic latex formed by radical polymerization of at least one (meth)acrylic unit containing monomer in an aqueous medium containing substantially no coalescing agents. The coatings composition formed from the single stage acrylic latex also contains substantially no coalescing agents.

### CROSS-REFERENCE TO RELATED APPLICATIONS

The present application is related to, and claims priority to, U.S. Provisional Application Ser. No. 63/493,809, filed Apr. 3, 2023, pending, the entire contents of which are incorporated herein by reference.

### TECHNICAL FIELD

In general, the present invention relates to a waterborne latex using a single stage acrylic latex with substantially no coalescing agents, and more particularly, to coatings formed from the single stage acrylic latex.

### BACKGROUND OF THE INVENTION

The US paint and coatings industry includes more than 1,000 companies with combined annual sales in excess of $20 billion and continues to grow. Many coatings comprise a waterborne latex due to, for example, reduced emissions of volatile organic compounds (VOC), improved ease of clean-up and application, and reduced flammability when compared to solvent borne coatings. A waterborne latex at least includes a polymer dispersed in water. Upon applying a waterborne latex-based coating to a substrate, the water evaporates, and the remaining polymer coalesces to form a continuous, cured film on the substrate. The formulation of the waterborne latex-based coating may at least depend on the properties of the application substrate, the humidity and temperature of the application surface and surrounding environment, the VOCs emission standards to protect the environment, and the final cost and ease of application for the final customer.

To achieve a high-performing coating in view of such constraints and conditions, waterborne latex-based coatings may further comprise dispersants, surfactants, thickeners, pigments, and coalescing agents. Coalescing agents assist with coalescence of the waterborne latex-based coating as it dries to form a continuous film on the substrate. Without coalescing agents, or with a coalescing agent that is incompatible with the latex-based resin coating system, a waterborne latex-based coating may crack and peel as it dries, especially if a hard film is desired upon drying. This is exemplified in FIG. 1, in which a multi-stage latex having an incompatible coalescing agent therein was cured, resulting in a significantly cracked surface. Unfortunately, coalescing agents comprise solvents, and thus, produce VOCs as the coalescing agent evaporates during drying of the waterborne latex-based coating.

### SUMMARY OF THE INVENTION

In accordance with an embodiment of the present invention, a latex is provided. The latex may comprise a single stage acrylic latex formed by radical polymerization of at least one (meth)acrylic unit containing monomer in an aqueous medium containing substantially no coalescing agents. The latex contains substantially no coalescing agents.

A further object of the present invention is to provide such a latex having VOCs of less than 50 grams per liter, as determined in accordance with ASTM D6886.

A further object of the present invention is to provide a coating composition comprising such a latex, where the coating composition can be applied to a substrate at a temperature in a range from 20 degrees Celsius to 90 degrees Celsius.

A further object of the present invention is to provide a coating composition comprising such a latex, where the coating composition can be applied to a fiber cement board and dry as a continuous, cured coating on the fiber cement board.

These and other objects of this invention, alone or in combination, have been satisfied by the discovery of a latex comprising a single stage acrylic latex comprising at least one (meth)acrylic unit containing monomer and containing substantially no coalescing agents. The latex and coating composition made therefrom will be further described in the following detailed description and appended claims.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a photomicrograph image of the cured surface of a multi-stage latex containing an incompatible coalescing agent at 100× magnification.

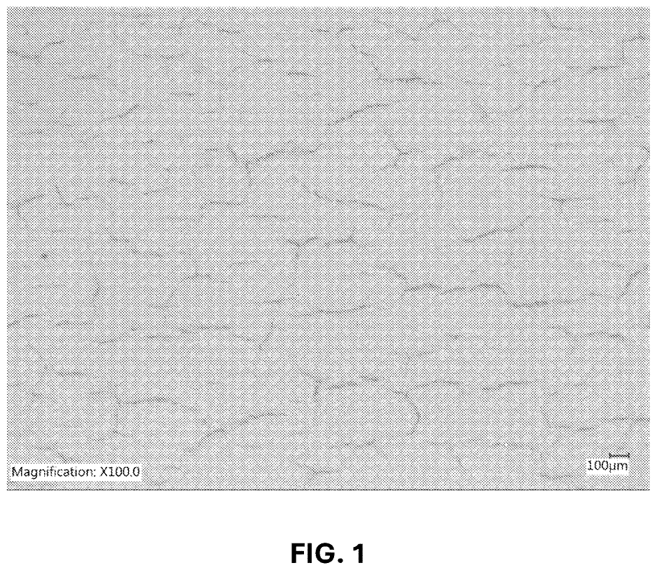

FIG. 2 is a photomicrograph image of the cured surface of a single-stage acrylic latex of the present invention containing no coalescing agent at 100× magnification.

### DETAILED DESCRIPTION OF THE INVENTION

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an” additive means that the coating composition can include “one or more” additives.

Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur-this distinction is captured by the terms “may” and “may be.”

The term “acrylic” as used herein includes (meth)acrylic acid, (meth)alkyl acrylate, (meth)acrylamide, (meth)acrylonitrile and their modified forms such as (meth)hydroxyalkyl acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

The term “aqueous” composition or dispersion herein means that particles are dispersed in an aqueous medium. An “aqueous medium” herein has a continuous phase of water that makes up at least 50 weight percent of the aqueous medium, wherein the remaining composition of the aqueous medium comprises particles and water-miscible compound(s) such as, for example, alcohols, glycols, glycol ethers, glycol esters, and the like.

The term “(co)polymer” as used herein includes both homopolymers (polymers containing units from a single monomer) and copolymers (polymers containing units from two or more different monomers), unless otherwise specifically stated.

The term “glass transition temperature” or “Tg” in the present invention can be measured by various conventional techniques including, for example, differential scanning calorimetry (“DSC”) or calculation by using a Fox equation. DSC data and methods described herein are in accordance with ASTM D6604-00.

The term “(meth)acrylic acid” includes either or both of acrylic acid and methacrylic acid, and the term “(meth)acrylate” includes either or both of an acrylate and a methacrylate.

The term “multistage” when used with respect to a latex means the latex polymer was made using discrete charges of two or more monomers or was made using a continuously-varied charge of two or more monomers. Usually, a multistage latex will not exhibit a single Tg inflection point as measured using DSC. For example, a DSC curve for a multistage latex made using discrete charges of two or more monomers may exhibit two or more Tg inflection points. Also, a DSC curve for a multistage latex made using a continuously-varied charge of two or more monomers may exhibit no Tg inflection points. Occasionally when only one Tg inflection point is observed it may be difficult to determine whether the latex represents a multistage latex. In such cases a lower Tg inflection point may sometimes be detected on closer inspection, or the synthetic scheme used to make the latex may be examined to determine whether or not a multistage latex would be expected to be produced.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

The term “single stage” when used with respect to a latex means the latex polymer was made using a single monomer or a non-varying charge of two or more monomers. Usually, a DSC curve for a single stage latex made using a single monomer charge or a non-varying charge of two monomers may exhibit only a single Tg inflection point.

The phrase “substantially no coalescing agents” when used with respect to the single stage latex means that coalescing agents make up preferably less than 5 percent by weight (wt. %) of the single stage latex, more preferably less than 3 wt. % of the single stage latex, even more preferably less than 1.3 wt. % of the single stage latex, still even more preferably less than 0.5 wt %, still even more preferably less than 0.25 wt %, still even more preferably less than 0.10 wt %, still even more preferably less than 0.05 wt %, and most preferably 0 wt. % of the single stage latex.

As used herein, the term “structural units,” also known as polymerized units, of the named monomer refers to the remnant of the monomer after polymerization, or the monomer in polymerized form.

Embodiments of the invention disclosed herein relate to a waterborne latex-based coating composition and its corresponding cured coating. The coating composition may comprise a single stage acrylic latex, comprise substantially no coalescing agents, and comprise other coatings components such as surfactants, fillers, pigments, and/or the like. When the coating composition disclosed herein is applied to a substrate, the polymer in the single stage acrylic latex still sufficiently coalesces as the coating composition dries to form a cured coating over the substrate. The cured coating is a continuous film that sufficiently adheres to and provides sufficient protection to the substrate under various conditions.

Sufficient protection of the substrate at least depends on the surrounding environment and the substrate's intended use. Further, when the cured coating sufficiently adheres to the substrate, the cured coating is substantially resistant to peeling and cracking upon formation and over time. A harder cured coating may be desired in applications where the coated substrate will be exposed to debris, force, varying weather conditions, and other harsh conditions. For example, cured coatings on doors and trim in a residence may be harder than the cured coatings on the walls of the residence because doors and trim usually withstand more dings from furniture, shoes, vacuums, and the like. Similarly, to withstand varying weather conditions, cured coatings on substrates exposed to the outdoors are typically harder than cured coatings on substrates that remain indoors.

To increase the hardness of a cured coating, a corresponding coating composition may comprise a polymer with a higher glass transition temperature (Tg) when compared to coating compositions that do not require as hard as a cured coating and/or may comprise a multistage polymer. However, such coalescing agents contribute to higher VOCs in the overall coating composition, and such multi-stage polymers increase manufacturing complexity and costs. Various embodiments of the present disclosure provide a coating composition comprising a single stage acrylic latex, wherein the coating composition can still coalesce on and sufficiently protect a substrate without coalescing agents when the coating composition is applied to the substrate at elevated temperatures.

With substantially no coalescing agents, the VOCs of the single stage acrylic latex are substantially eliminated such that the VOCs of the coating composition formed therefrom are reduced. A coating composition with reduced VOCs is safer for the environment and the consumer during application. For example, in some embodiments, the single stage acrylic latex may comprise, for example, preferably less than 50 g/L, more preferably less than 20g/L VOCs, even more preferably 10 g/L VOCs, still even more preferably less than 5 g/L VOCs, and most preferably complete absence of VOCs. Thus, in some such embodiments of the present disclosure, when a coating composition comprises the disclosed single stage acrylic latex with substantially no coalescing agents, the coating composition comprises less VOCs than other coating compositions comprising a single stage acrylic latex with coalescing agents or comprising multistage latexes. For example, in some embodiments, the coating composition disclosed herein may comprise, for example, less than 75 g/L, preferably less than 50 g/L VOCs, more preferably less than 25 g/L VOCs, still more preferably less than 10 g/L VOCs, even more preferably less than 5 g/L VOCs, and most preferably complete absence of VOCs. The VOCs may be measured based on ASTM D6886 or some other suitable industry-standard test method.

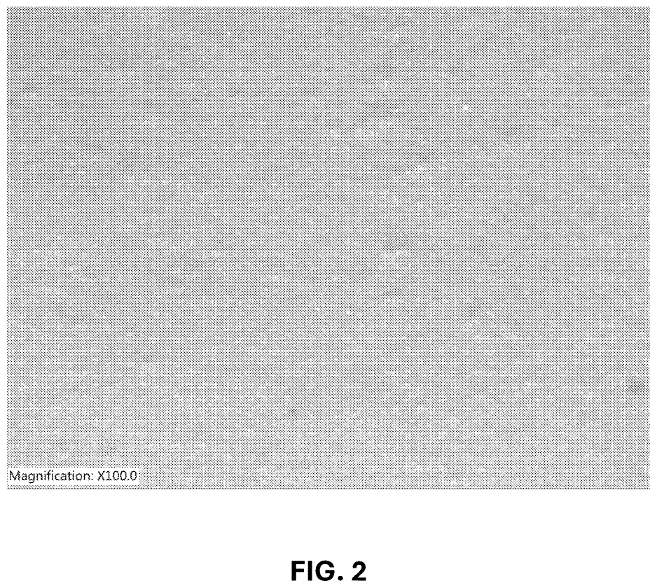

The disclosed coating composition comprising a single stage acrylic latex with substantially no coalescing agents forms a reliable cured coating on a substrate when the coating composition is applied to substrate at a temperature in the range of between, for example, approximately 20 degrees Celsius and approximately 90 degrees Celsius. The coatings composition can provide a hard, cured coating on the substrate for sufficient protection. FIG. 2 shows a photomicrograph image of the cured surface of a single-stage acrylic latex of the present invention containing no coalescing agent at 100× magnification. The resulting cured surface is reliably consistent, with no cracking or peeling, despite the lack of coalescing agent. To provide a harder cured coating, the Tg of the latex within the coatings composition is increased. To ensure sufficient coalescing, the substrate and/or the surrounding environment should be at a temperature greater than or equal to the Tg of the latex. At such higher application temperatures, the single stage acrylic latex is soft enough that it sufficiently coalesces to form the cured coating on a substrate upon drying and with substantially no coalescing agents. Thus, when it is known that the temperature of a substrate for coatings application is in a range of between, for example, approximately 20 degrees Celsius and approximately 90 degrees Celsius, the disclosed coating composition may be applied to the substrate and still form a reliable cured coating over the substrate. Upon drying, the cured coating may be sufficiently protective of the substrate when exposed to extremely low temperatures (e.g., less than 20 degrees Celsius) and extremely high temperatures (e.g., above about 90 degrees Celsius). For example, the cured coating may be sufficiently hard, resistant to cracking, and resistant to peeling when the coated substrate is in use and exposed to various conditions.

Except for the VOCs present during formation, in some embodiments, the reliable cured coating formed from the single stage acrylic latex with substantially no coalescing agents and at the aforementioned temperature range (e.g., about 20 degrees Celsius to about 90 degrees Celsius) may have the same or substantially similar properties as a cured coating that was formed with a single stage acrylic latex with coalescing agents and/or a multi-stage acrylic latex and that was formed at the aforementioned temperature range (e.g., about 20 degrees Celsius to about 90 degrees Celsius). In other words, under certain temperature conditions, the disclosed coating composition comprising a single stage acrylic latex with substantially no coalescing agents is configured to form a cured coating with the same or substantially the same properties when compared with other coating composition comprising single stage acrylic latexes with coalescing agents or comprising multistage latexes. With less ingredients and VOCs, the disclosed coating composition is cheaper, easier to handle, and better for the environment when compared to similar coating compositions that do comprise coalescing agents.

In some embodiments, the disclosed coating composition is particularly useful and reliable when the application temperature of the coating composition can be controlled. In the context of the present invention, the application temperature refers to the temperature of the substrate to which the coating composition is being applied, the surrounding environment in which the coating composition is being applied, or both. For example, in some embodiments, a substrate is coated with the coating composition during manufacturing when the substrate and its surrounding environment is still consistently warm (e.g., between about 20 degrees Celsius and about 90 degrees Celsius). In some other embodiments, a coating composition may be applied to in a climate that is typically warm (e.g., between about 20 degrees Celsius and about 60 degrees Celsius). For example, the coating composition may coalesce when applied to the exterior of a house situated in a hot climate such as, for example, in Central America. In some other embodiments, the disclosed single stage polymer latex may coalesce when applied at temperatures in a range of between, for example, approximately 30 degrees Celsius to approximately 80 degrees Celsius. In yet some other embodiments, the disclosed single stage polymer latex may coalesce when applied and dried at temperatures in a range of between, for example, approximately 30 degrees to approximately 70 degrees Celsius.

In some embodiments, the disclosed coating composition may form a reliable cured coating when formed at a particular temperature over a substrate comprising, for example, cement, cement board, fiber cement board, wood, metal, glass, plastic (e.g., a vinyl), paper, leather, fabric, ceramic, a composite material, the like, and any combination thereof. Thus, the disclosed coating composition that comprises substantially no coalescing agents can still sufficiently cover and protect substrates that have significant texture and surface roughnesses just as well as coatings that do comprise coalescing agents and/or do comprise a multistage latex. The disclosed cured coatings formed with substantially no coalescing agents may have a dry film thickness in a range from, for example, 0.3 mils to approximately 10 mils (approximately 7.6 micrometers to approximately 254 micrometers). In some other embodiments, the disclosed cured coatings formed with substantially no coalescing agents may have a dry film thickness in a range from, for example, 0.3 mils to approximately 2.2 mils (approximately 7.6 micrometers to approximately 55.9 micrometers). Such dry film thickness values indicate that the cured coating is a continuous film without cracking. The disclosed coating composition may have less VOCs and ingredients than a coating composition comprising a coalescing agent or multistage latex, but may also have substantially the same mildew growth, cold stability, heat stability, shelf-life stability, pH, UV-exposure, and the like as a coating composition comprising a coalescing agent or multistage latex.

In some embodiments, the coating composition may be applied to a substrate during manufacturing and prior to installation of the resulting precoated substrate. In some such embodiments, the coating composition may be hard enough to protect the substrate during further manufacturing steps, packaging, transportation, and installation. Additionally, the end user can forego the application of a primer to the substrate after installation, thereby saving time, money, and effort. In some such embodiments, the end user may only need to apply at least one top coat to the substrate for further protection or overall aesthetics (e.g., sheen, color, etc.) of the substrate.

As an example, a cement board may be precoated with a coating composition upon manufacturing in order to protect the cement board during packaging, transport, and installation. In particular, fiber cement boards are more durable than wood and thus, may be used for outdoor siding of a building while still providing a wood-like appearance. The fiber cement boards are a generally planar component suitable for attachment to a building exterior surface, including lap siding, vertical siding, soffit panels, trim boards, shingle replicas, stucco replicas, and the like. A variety of suitable fiber cement substrates are commercially available. Fiber cement boards may comprise organic materials, inorganic materials, or a combination of organic and inorganic materials. For example, in some embodiments, a fiber cement board may comprise cement with fiber-reinforcements and other additives to achieve suitable properties. Examples of fiber-reinforcements may include but are not limited to cellulose fibers or synthetic fibers. In some embodiments, for example, fiber cement boards comprise cement and cellulose fibers. In some other embodiments, fiber cement boards comprise sand, water, cement, and cellulose fibers. Further, in some embodiments, a fiber cement board further comprises chemically bonded additives to provide, for example, moisture resistant, fire resistant, and other desired properties. In some embodiments, in addition to surface texture, a fiber cement board may have some type of curvature or sloped surface to force water and other contaminants out and away from the structure that the fiber cement board is protecting. Other suitable examples of the fiber cement board are disclosed in U.S. Pat. No. 8,993,110, the relevant portions of which are incorporated by reference herein. Examples of suitable fiber cement siding products include, but are not limited to, products available from Allura USA of Houston, Texas, products available from James Hardie Building Products Inc. of Mission Viejo, California, products available from Knauf USG Systems GmbH & Co. KG of Iserlohn, Germany, products available from Cemplank of Mission Viejo, California; products available from CertainTeed Corporation of Valley Forge, Pennsylvania; products available from MaxiTile Inc. of Carson, California; products available from Nichiha U.S.A., Inc. of Norcross, Georgia, products available from Zhangjiagang Evernice Building Materials Co., Ltd. of China and products available from Everest Industries Ltd. of India.

During production of a substrate, the temperature of the substrate can be controlled. In some embodiments, the coating composition may be applied to a warm substrate by way of roll coating, spray coating, curtain coating, dip coating, brush coating, or some other suitable coating process. At least a portion of the warm substrate is coated with the coating composition. For example, when a fiber cement board is formed, it exits an oven or autoclave at an elevated temperature such as, for example, between about 30 degrees Celsius and about 60 degrees Celsius. Therefore, the disclosed coating composition may be applied to the warm fiber cement board and sufficiently coalesce without coalescing agents. In some embodiments, only one side of the fiber cement board is coated, whereas in other embodiments, both sides of the fiber cement board are coated. The coated fiber cement board may then be loaded into an oven or autoclave for a predetermined curing time to cure the coating composition on the fiber cement board. The cured, coated fiber cement board may then be packaged and shipped quickly thereafter. In other embodiments, the cured, coated fiber cement may also be stored in a warehouse until it has sold. Regardless, the cured coating formed from the coating composition disclosed herein can sufficiently protect the fiber cement board or some other substrate when exposed to various temperatures, weather conditions, and the like.

The latex disclosed herein is a single stage acrylic latex. The single stage acrylic latex may be formed by radical polymerization of at least one (meth)acrylic unit containing monomer. The single stage acrylic is dispersed in an aqueous medium that is waterborne. In some embodiments, the single stage acrylic latex comprises substantially no coalescing agents and thus, comprises substantially no VOCs. More preferably, coalescing agents and VOCs are completely absent from the single stage acrylic latex.

In some embodiments, the at least one (meth)acrylic unit containing monomer is at least one member selected from the group consisting of alkyl (meth)acrylate), C₁-C₆ alkyl (meth)acrylate, methyl methacrylate, methyl acrylate, ethyl methacrylate, ethyl acrylate, isopropyl acrylate, isopropyl methacrylate, n-propyl acrylate, n-propyl methacrylate, n-butyl acrylate, n-butyl methacrylate, isobutyl acrylate, isobutyl methacrylate, t-butyl acrylate, t-butyl methacrylate, n-pentyl acrylate, n-pentyl methacrylate, isopentyl acrylate, isopentyl methacrylate, neopentyl acrylate, neopentyl methacrylate, n-hexyl acrylate, n-hexyl methacrylate, isohexyl acrylate, isohexyl methacrylate, neohexyl acrylate, neohexyl methacrylate, cyclobutyl acrylate, cyclobutyl methacrylate, cyclopentyl acrylate, cyclopentyl methacrylate, cyclohexyl acrylate, and cyclohexyl methacrylate.

A coating composition may be formed from the single stage acrylic latex. In some embodiments, the coating composition may further comprise at least one additional acrylic latex, wherein the at least one additional acrylic latex comprises an acrylic copolymer. In some embodiments, the acrylic copolymer comprises at least one (meth)acrylic unit containing monomer, and a further monomer which may be a (meth)acrylic unit containing monomer or an unsaturated monomer with no (meth)acrylic unit. In some embodiments, the coating composition may further comprise polymers of like synergies as the single stage acrylic latex polymer, such as, for example, an epoxy, a urethane, or the like. The coating composition also generally can comprise numerous other additives and components, as are conventional or as otherwise may be found suitable in a coating composition. Examples of suitable additives may include but are not limited to any one or more of neutralizing agents, antifoaming agents, fillers, dyes, dispersants, surfactants, extenders, adhesion promoters, wetting agents, rheology modifiers, leveling agents, deflocculants, anti-blocking agents, antimicrobials such as mildewcides, fungicides, algaecides, and bactericides, other preservatives, thickeners, thixotropic agents, drying agents, anti-settling agents, rust inhibitors, flattening agents, pigments, hardeners, and combinations thereof. Suitable examples of the various optional components are presented herein and also disclosed in U.S. Pat. No. 8,993,110, the relevant portions of which are incorporated by reference herein.

The amount and number of coatings components in the coating composition may depend on the desired properties of the coating composition and the cured coating formed therefrom. The desired properties may depend on the material of the substrate, the use of the substrate, the surrounding environment during application of the coating composition, the surrounding environment that the coated substrate will be exposed to, and the like. In some embodiments, the coating components may be adjusted for aesthetics. For example, the coating composition may be formulated to achieve a desired finish and color of the cured coating formed therefrom. For example, the coating composition disclosed herein may coalesce on a warm substrate without coalescing agents to form a cured coating that is flat, satin, or eggshell, for example. A gloss finish may also be achieved but it is typically not a preferred finish when used as a primer or exterior coating.

Any suitable rheology modifier may be incorporated into a coating composition. Examples of polyurethane rheology modifiers may include but are not limited to nonionic, solvent-free, hydrophobically modified ethylene oxide urethane (HEUR) rheology modifiers and nonionic urethane rheology modifiers.

The coating composition can include any suitable surfactant. Examples of phosphate surfactants may include but are not limited to phosphate esters such as methyl phosphate, 2-ethylhexyl phosphate, decyl alcohol ethoxylated phosphate esters, lauryl alcohol ethoxylated phosphate esters, n-octyl phosphate, nonylphenol ethoxylated phosphate esters, octyl phenol ethoxylated phosphate esters, styrenated phenol ethoxylated phosphate esters, tridecyl alcohol ethoxylated phosphate esters, etc.

Any suitable dispersant, such as any one or more of anionic dispersants, cationic dispersants, amphoteric dispersants, or nonionic dispersants may be used in the coating composition. Examples of dispersants may include but are not limited to 2-amino-2-methyl-1-propanol, pyrophosphates such as tetrapotassium pyrophosphate and tetrasodium pyrophosphate, tripolyphosphates such as potassium tripolyphosphate and sodium tripolyphosphate, etc. Any suitable wetting agents such as any one or more of anionic wetting agents, cationic wetting agents, amphoteric wetting agents, or nonionic wetting agents may be used. Any suitable deflocculant, such as sodium potassium tripolyphosphate, can be used.

The coating composition may, if desired, include one or more fillers or extenders. Examples of fillers may include but are not limited to sodium-potassium alumina silicates, calcium carbonate, and the like. When used, such fillers may be employed in any desired amount.

Useful antimicrobial additives include phosphates, zeo-lites, hydroxyapatites, organic acids, phenols, alcohols, qua-ternary ammonium compounds, additives containing metal ions such as ions of silver, zinc, and copper, etc.

Any suitable drying agent may be included in a coating composition. Examples of drying agents may include but are not limited to metal-based catalysts such as an iron-complex catalyst, a cobalt-free and metal-based catalyst, a zirconium-based catalyst, and the like. Preferably, suitable drying agents are free of VOCs.

One or more types of pigment may be included in a coating composition via any suitable technique, such as by adding raw pigment or a pigment vehicle during manufac-ture of the composition or by instilling a pigment at the point of sale. Examples of pigments may include but are not limited to azo pigments, anazurite, aluminum silicate, aluminum potassium silicate, aluminum paste, anthraquinone pigments, antimony oxide, barium metaborate, barium sulfate, cadmium sulfide, cadmium selenide, calcium carbonate, calcium metaborate, calcium meta-silicate, carbon black, chromium oxides, clay, copper oxides, copper oxychloride, dioxazine pigments, feldspar, hansa yellows azo pigments (some of which are listed above), benzimidazolones, iron oxides such as yellow and red iron oxides, isoindoline pigments, kaolinite, lithopone, magnesium silicates, metallic flakes, mica, napthol pigments such as napthol reds, nitroso pigments, nepheline syenite, perinone pigments, perylene pigments, polycyclic pigments, pyrropyrrol pigments, pthalocyanines such as copper pthalocyanine blue and copper pthalocyanine green, quinacri-dones such as quinacridone violets, quinophthalone pig-ments, silicates, sulfides, talc, titanium dioxide, ultramarine, zinc chromate, zinc oxide, and zinc phosphate. In addition, pearlescents, optical brighteners, ultraviolet stabilizers, and the like may be added to a coating composition. Titanium dioxide is a preferred pigment/whitening agent.

Upon applying the coating composition to a substrate, the composition will cure to form a cured coating. In some embodiments, initial curing periods span a period of, for example, less than four weeks from the time of application of a coating composition. In some embodiments, initial curing periods range from, for example, eighteen hours to four weeks, one day to three weeks, three days to two weeks, and one week to two weeks. Additionally, as mentioned above, curing times may be accelerated when the coated substrate is heated.

Once prepared, the coating composition may be dispensed into any desired storage container, such as a paint can. The coating composition then may be transported and stored, such as in a warehouse or on a store shelf.

A method of applying a coating composition can comprise applying the coating composition to a substrate at a warm temperature (e.g., between about 20 degrees Celsius and about 90 degrees Celsius) and allowing the coating composition to cure. Once applied to the substrate, the coating composition will cure, typically as the composition coalesces.

Thus, various components of the disclosed coating composition may be adjusted based on the coatings application. As long as the coating composition comprises the single stage acrylic latex and is applied to a warm substrate, the resulting cured coating can have substantially the same properties as other single stage acrylic latex coatings or multistage latex coatings but with reduced VOCs.

The following are non-limiting examples of some embodiments of the present invention:
Embodiment 1. A latex comprising:
   a single stage acrylic latex formed by radical polymerization of at least one (meth)acrylic unit containing monomer in an aqueous medium containing substantially no coalescing agents.
Embodiment 2. The latex of Embodiment 1, wherein the latex contains no coalescing agent.
Embodiment 3. The latex of one of Embodiments 1 or 2, wherein the latex has a volatile organic content (VOC) of less than 50 g/L, as determined in accordance with ASTM D6886.
Embodiment 4. The latex of any one of Embodiments 1-3, wherein the latex has a VOC of less than 5 g/L, as determined in accordance with ASTM D6886.
Embodiment 5. The latex of any one of Embodiments 1-4, wherein the latex has substantially no VOC, as determined in accordance with ASTM D6886.
Embodiment 6. The latex of any one of Embodiments 1-5, wherein the at least one (meth)acrylic unit containing monomer is at least one alkyl (meth)acrylate.
Embodiment 7. The latex of any one of Embodiments 1-6, wherein the at least one (meth)acrylic unit containing monomer is at least one C1-C6 alkyl (meth)acrylate.
Embodiment 8. The latex of any one of Embodiments 1-7, wherein the at least one (meth)acrylic unit containing monomer is the at least one member selected from the group consisting of methyl methacrylate, methyl acrylate, ethyl methacrylate, ethyl acrylate, isopropyl acrylate, isopropyl methacrylate, n-propyl acrylate, n-propyl methacrylate, n-butyl acrylate, n-butyl methacrylate, isobutyl acrylate, isobutyl methacrylate, t-butyl acrylate, t-butyl methacrylate, n-pentyl acrylate, n-pentyl methacrylate, isopentyl acrylate, isopentyl methacrylate, neopentyl acrylate, neopentyl methacrylate, n-hexyl acrylate, n-hexyl methacrylate, isohexyl acrylate, isohexyl methacrylate, neohexyl acrylate, neohexyl methacrylate, cyclobutyl acrylate, cyclobutyl methacrylate, cyclopentyl acrylate, cyclopentyl methacrylate, cyclohexyl acrylate, and cyclohexyl methacrylate.
Embodiment 9. A coating composition comprising the latex of any of Embodiments 1-8, wherein the coating also contains substantially no coalescing agents.
Embodiment 10. The coating composition of Embodiment 9, further comprising at least one additional acrylic latex, wherein at least one additional acrylic latex comprises an acrylic copolymer.
Embodiment 11. The coating composition of one of Embodiments 9 or 10, further comprising at least one member selected from the group consisting of plasticizers, thickeners, defoamers, surfactants, dispersants, matting agents, solvents, antimicrobial agents, pigments, hardeners, pH adjusters, and combinations thereof.
Embodiment 12. The coating composition of any one of Embodiments 10-11, wherein the acrylic copolymer of the one additional acrylic latex is a copolymer of at least one (meth)acrylic unit containing monomer, and a further monomer which may be a (meth)acrylic unit containing monomer or an unsaturated monomer with no (meth)acrylic unit.
Embodiment 13. A coating formulation for preparing the coating composition of any one of Embodiments 9-12, comprising:
   a single stage acrylic latex formed by radical polymerization of at least one (meth)acrylic unit containing monomer in an aqueous medium containing substantially no coalescing agents.
Embodiment 14. The coating formulation of Embodiment 13, further comprising at least one additional acrylic latex, wherein at least one additional acrylic latex comprises an acrylic copolymer.
Embodiment 15. The coating formulation of one of Embodiments 13 or 14, further comprising at least one member selected from the group consisting of plasticizers, thickeners, defoamers, surfactants, dispersants, matting agents, solvents, antimicrobial agents, pigments, hardeners, pH adjusters, and combinations thereof.
Embodiment 16. The coating formulation of any one of Embodiments 13-15, wherein the acrylic copolymer of the one additional acrylic latex is a copolymer of at least one (meth)acrylic unit containing monomer, and a further monomer which may be a (meth)acrylic unit containing monomer or an unsaturated monomer with no (meth)acrylic unit.
Embodiment 17. A coated substrate, comprising the coating of any one of Embodiments 9-12, applied to at least a portion of a substrate.
Embodiment 18. The coated substrate of Embodiment 17, wherein the substrate comprises at least one member selected from the group consisting of wood, metal, glass, plastic, paper, leather, fabric, ceramic, cement, cement board, composite material, and any combination thereof.
Embodiment 19. The coated substrate of one of Embodiments 17 or 18, wherein the coating composition is applied to the substrate at a temperature in a range from 20° C. to 90° C.
Embodiment 20. The coated substrate of any one of Embodiments 17-19, wherein the coating composition is applied to the substrate at a temperature in a range from 30° C. to 70° C.
Embodiment 21. The coated substrate of any one of Embodiments 17-20, wherein the substrate is a member selected from the group consisting of cement and cement board.
Embodiment 22. The coated substrate of any one of Embodiments 17-21, wherein the substrate is a fiber cement board.
Embodiment 23. The coated substrate of any one of Embodiments 17-22, wherein the coating composition is applied to the substrate by a method selected from the group consisting of roll coating, spray coating, curtain coating, dip coating, and brush coating.
Embodiment 24. The coated substrate of any one of Embodiments 17-23, wherein the coating composition after drying has a thickness of from 0.3 to 10 mil.
Embodiment 25. The coated substrate of any one of Embodiments 17-24, wherein the coating composition after drying has a thickness of from 0.3 to 2.2 mil.

All methods described herein can be performed in any suitable order unless otherwise indicated herein or otherwise clearly contradicted by context. The use of any examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

While the embodiments discussed herein have been related to the coatings and methods discussed above, these embodiments are intended to be examples only and are not intended to limit the applicability of these embodiments to only those discussions set forth herein.

The above description is merely illustrative of several possible embodiments of various aspects of the present invention, wherein equivalent alterations and/or modifications will occur to others skilled in the art upon reading and understanding this specification and the annexed drawings. In addition, although a particular feature of the invention may have been disclosed with respect to only one of several implementations, such feature may be combined with one or more other features of the other implementations as may be desired and advantageous for any given or particular application.

Additional modifications and variations of the present invention are possible in light of the above teachings. It is therefore to be understood that within the scope of the appended claims, the invention may be practiced otherwise than as specifically described herein.

1. A latex comprising:
a single stage acrylic latex formed by radical polymerization of at least one (meth)acrylic unit containing monomer in an aqueous medium containing substantially no coalescing agents.

2. The latex of claim 1, wherein the latex contains no coalescing agent.

3. The latex of claim 1, wherein the latex has a volatile organic content (VOC) of less than 50 g/L, as determined in accordance with ASTM D6886.

4. The latex of claim 3, wherein the latex has a VOC of less than 5 g/L, as determined in accordance with ASTM D6886.

5. The latex of claim 3, wherein the latex has substantially no VOC, as determined in accordance with ASTM D6886.

6. The latex of claim 1, wherein the at least one (meth)acrylic unit containing monomer is at least one alkyl (meth)acrylate.

7. The latex of claim 1, wherein the at least one (meth)acrylic unit containing monomer is at least one C1-C6 alkyl (meth)acrylate.

8. The latex of claim 1, wherein the at least one (meth)acrylic unit containing monomer is the at least one member selected from the group consisting of methyl methacrylate, methyl acrylate, ethyl methacrylate, ethyl acrylate, isopropyl acrylate, isopropyl methacrylate, n-propyl acrylate, n-propyl methacrylate, n-butyl acrylate, n-butyl methacrylate, isobutyl acrylate, isobutyl methacrylate, t-butyl acrylate, t-butyl methacrylate, n-pentyl acrylate, n-pentyl methacrylate, isopentyl acrylate, isopentyl methacrylate, neopentyl acrylate, neopentyl methacrylate, n-hexyl acrylate, n-hexyl methacrylate, isohexyl acrylate, isohexyl methacrylate, neohexyl acrylate, neohexyl methacrylate, cyclobutyl acrylate, cyclobutyl methacrylate, cyclopentyl acrylate, cyclopentyl methacrylate, cyclohexyl acrylate, and cyclohexyl methacrylate.

9. A coating composition comprising the latex of claim 1, wherein the coating also contains substantially no coalescing agents.

10. The coating composition of claim 9, further comprising at least one additional acrylic latex, wherein at least one additional acrylic latex comprises an acrylic copolymer.

11. The coating composition of claim 9, further comprising at least one member selected from the group consisting of plasticizers, thickeners, defoamers, surfactants, dispersants, matting agents, solvents, antimicrobial agents, pigments, hardeners, pH adjusters, and combinations thereof.

12. The coating composition of claim 10, wherein the acrylic copolymer of the one additional acrylic latex is a copolymer of at least one (meth)acrylic unit containing monomer, and a further monomer which may be a (meth)acrylic unit containing monomer or an unsaturated monomer with no (meth)acrylic unit.

13. A coating formulation for preparing the coating composition of claim 9, comprising:
a single stage acrylic latex formed by radical polymerization of at least one (meth)acrylic unit containing monomer in an aqueous medium containing substantially no coalescing agents.

14. The coating formulation of claim 13, further comprising at least one additional acrylic latex, wherein at least one additional acrylic latex comprises an acrylic copolymer.

15. The coating formulation of claim 14, further comprising at least one member selected from the group consisting of plasticizers, thickeners, defoamers, surfactants, dispersants, matting agents, solvents, antimicrobial agents, pigments, hardeners, pH adjusters, and combinations thereof.

16. The coating formulation of claim 14, wherein the acrylic copolymer of the one additional acrylic latex is a copolymer of at least one (meth)acrylic unit containing monomer, and a further monomer which may be a (meth)acrylic unit containing monomer or an unsaturated monomer with no (meth)acrylic unit.

17. A coated substrate, comprising the coating composition of claim 9, applied to at least a portion of a substrate.

18. The coated substrate of claim 17, wherein the substrate comprises at least one member selected from the group consisting of wood, metal, glass, plastic, paper, leather, fabric, ceramic, cement, cement board, composite material, and any combination thereof.

19. The coated substrate of claim 17, wherein the coating composition is applied to the substrate at a temperature in a range from 20° C. to 90° C.

20. The coated substrate of claim 17, wherein the coating composition is applied to the substrate at a temperature in a range from 30° C. to 70° C.

21. The coated substrate of claim 17, wherein the substrate is a member selected from the group consisting of cement and cement board.

22. The coated substrate of claim 17, wherein the substrate is a fiber cement board.

23. The coated substrate of claim 17, wherein the coating composition is applied to the substrate by a method selected from the group consisting of roll coating, spray coating, curtain coating, dip coating, and brush coating.

24. The coated substrate of claim 17, wherein the coating composition after drying has a thickness of from 0.3 to 10 mil.

25. The coated substrate of claim 17, wherein the coating composition after drying has a thickness of from 0.3 to 2.2 mil.
